(19) United States
(12) Patent Application Publication
(10) Pub. No.: US 2015/0074334 A1
(43) Pub. Date: Mar. 12, 2015

(54) INFORMATION PROCESSING DEVICE

(71) Applicant: KABUSHIKI KAISHA TOSHIBA, Minato-ku (JP)

(72) Inventors: Nobuhiro Kondo, Yokohama-shi (JP); Konosuke Watanabe, Cambridge, MA (US)

(73) Assignee: KABUSHIKI KAISHA TOSHIBA, Minato-ku (JP)

(21) Appl. No.: 14/200,208

(22) Filed: Mar. 7, 2014

Related U.S. Application Data
(60) Provisional application No. 61/875,903, filed on Sep. 10, 2013.

(51) Int. Cl. G06F 12/02

(52) U.S. Cl. CPC G06F 12/0246
USPC 711/103

(57) ABSTRACT

According to one embodiment, an information processing device is disclosed. The device includes a host device and a memory device. The host device includes a first memory portion to store first data and tag information corresponding to the first data, and a host controller to control input and output of data for the first memory portion. The memory device includes a nonvolatile semiconductor memory, and a device controller to control input and output of data for the nonvolatile semiconductor memory, and to transmit an input and output request for data to the host controller. In response to the device controller transmits an output request, the host controller reads the first data and the tag information from the first memory portion based on the output request, and outputs the first data and the tag information to the device controller.

### CROSS-REFERENCE TO RELATED APPLICATIONS

This application claims the benefit of U.S. Provisional Application No. 61/875,903, filed Sep. 10, 2013, the entire contents of which are incorporated herein by reference.

### FIELD

Embodiments described herein relate generally to an information processing device.

### BACKGROUND

A UMA (Unified Memory Architecture) is a technique in which one memory is shared in arithmetic processors such as a GPU (Graphical Processing Unit) in which arithmetic processors are integrated. In recent years, a memory system utilizing the UMA has been proposed.

### BRIEF DESCRIPTION OF THE DRAWINGS

FIG. 1 is a block diagram showing a basic configuration of an information processing device according to a first embodiment;

FIG. 2 is a view showing a memory structure of a device use area according to the first embodiment;

FIG. 3 is a view showing a memory structure of an L2P cache tag area and L2P cache area in the device use area according to the first embodiment;

FIG. 4 is a view showing a memory structure of a write cache tag area and write cache area in the device use area according to the first embodiment;

FIG. 5 is a view showing a data structure example of a write command according to the first embodiment;

FIG. 6 is a table showing an example of format of a data transfer command according to the first embodiment;

FIG. 7 is a view showing an example of flags included in the data transfer command (Access UM Buffer) according to the first embodiment;

FIG. 8 is a view showing an operation of transmitting L2P tag information and L2P table cache by a memory system according to the first embodiment;

FIG. 9 is a view showing an operation of reading L2P tag information and L2P table cache by a memory system according to the first embodiment;

FIG. 10 is a view showing a memory structure of a device use area according to a modification of the first embodiment;

FIG. 11 is a view showing an operation of reading the L2P tag information and the L2P table cache by a memory system according to a modification of the first embodiment;

FIG. 12 is a view showing a memory structure of L2P cache tag area and L2P cache area in a device use area according to a second embodiment;

FIG. 13 is a view showing an operation of reading L2P tag information and L2P table cache by a memory system according to the second embodiment;

FIG. 14 is a block diagram schematically showing a configuration of an information processing device according to a third embodiment; and

FIG. 15 is a view showing an operation of reading L2P table cache by a memory system according to the third embodiment.

### DETAILED DESCRIPTION

Embodiments will be described hereinafter with reference to the drawings. In the following description, the same reference numerals denote components having nearly the same functions and configurations, and a repetitive description thereof will be given if necessary. Also, embodiments to be described hereinafter exemplify an apparatus and method required to embody the technical idea of the embodiments, and do not limit materials, shapes, structures, layouts, or the like of components to those described hereinafter. The technical idea of the embodiments can be variously changed in the scope of the claims.

In general, according to one embodiment, an information processing device includes a host device and memory device. The host device includes a first memory portion and a host controller. The first memory portion stores first data and tag information corresponding to the first data. The host controller controls input and output of data for the first memory portion. The memory device includes a nonvolatile semiconductor memory and a device controller. The nonvolatile semiconductor memory stores data. The device controller controls input and output of data for the nonvolatile semiconductor memory, and transmits an input and output request for data to the host controller. In response to the device controller transmitting an output request, the host controller reads the first data and the tag information from the first memory portion based on the output request, and outputs the first data and the tag information to the device controller.

### First Embodiment

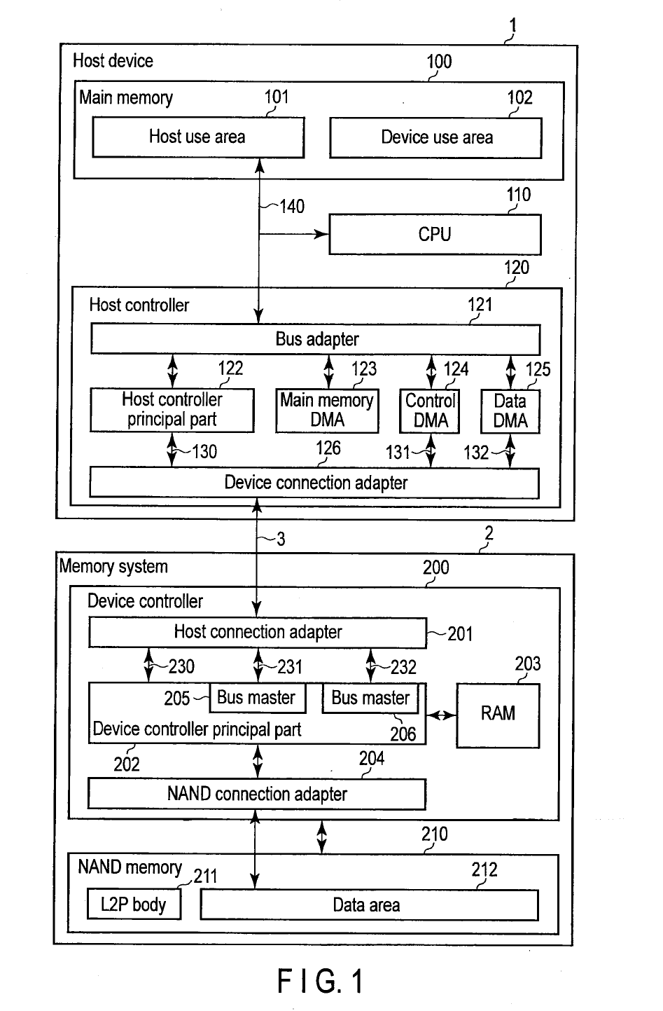

FIG. 1 is a block diagram showing a basic configuration of an information processing device according to the first embodiment.

An information processing device of the first embodiment comprises a host device (external device) 1 and a memory system 2 which functions as a storage device of the host device 1. The host device 1 and memory system 2 are connected by a communication path 3. A flash memory for embedded application, which is compliant with UFS (Universal Flash Storage) standard, SSD (Solid State Drive), or the like is applicable to the memory system 2. The information processing device is, for example, a personal computer, a mobile phone, an imaging device, or the like. As a communication standard of the communication path 3, for example, MIPI (Mobile Industry Processor Interface) UniPro and M-PHY are adopted.

<Overview of Memory System>

The memory system 2 includes a NAND flash memory 210 as a nonvolatile semiconductor memory, and a device controller 200 which executes data transfer between itself and the host device 1.

The NAND flash memory (to be referred to as “NAND memory” hereinafter) 210 is configured by one or more memory chips each including a memory cell array. The memory cell array includes a plurality of blocks. Each block includes a plurality of nonvolatile memory cells arranged in a matrix, and is configured by a plurality of pages. Each page is a unit for data read/write. Each nonvolatile memory cell is an electrically rewritable memory cell transistor, and has a floating gate electrode and a control gate electrode.

The NAND memory 210 has a Logical-to-Physical (L2P) address conversion table (to be referred to as “L2P table” hereinafter) 211 and a data area 212.

The L2P table 211 is one of pieces of management information required for the memory system 2 to function as an external storage device for the host device 1. That is, the L2P table 211 includes address conversion information for associating a logical block address (LBA) which is used when the host device 1 accesses the memory system 2 with a physical address (block address+page address+intra page storage location) in the NAND memory 210.

A Logical-to-Physical (L2P) cache area 300 (to be described later) in the host device 1 caches a part of this L2P table 211. In order to distinguish between the part of the L2P table 211 cached on the L2P cache area 300 and the L2P table 211 in the NAND memory 210, the L2P table 211 stored in the NAND memory 210 will be described as an L2P body 211 hereinafter.

The data area 212 stores data transmitted from the host device 1. Data stored in the data area 212 include, for example, an Operating System program (OS) required for the host device 1 to provide an execution environment, user programs executed by the host device 1 on the OS, data inputted and outputted by the OS or user programs, or the like.

The device controller 200 includes a host connection adapter 201 as a connection interface of the communication path 3, a NAND connection adapter 204 as a connection interface between itself and the NAND memory 210, a device controller principal part 202 which executes the control of the device controller 200, and a RAM 203.

The RAM 203 is used as a buffer for storing data to be written in the NAND memory 210 or data read from the NAND memory 210. In addition, the RAM 203 is used as a command queue for queuing commands related to a write request, read request, or the like input from the host device 1. For example, the RAM 203 can be configured by, for example, a small-scale SRAM (Static Random Access Memory), DRAM (Dynamic Random Access Memory), or the like. Alternatively, a register or the like may be substituted for the function of the RAM 203.

The device controller principal part 202 controls data transfer between the host device 1 and RAM 203 via the host connection adapter 201, and controls data transfer between the RAM 203 and NAND memory 210 via the NAND connection adapter 204. Especially, the device controller principal part 202 functions as a bus master in the communication path 3 between itself and the host device 1 to execute data transfer using a first port 230, and comprises two other bus masters 205 and 206. The bus master 205 can execute data transfer between itself and the host device 1 using a second port 231. The bus master 206 can execute data transfer between itself and the host device 1 using a third port 232. The roles of the ports 230 to 232 will be described later.

It is noted that the device controller principal part 202 is configured by, for example, a microcomputer unit comprising an arithmetic device and a storage device. The arithmetic device executes a firmware previously stored in the storage device to implement functions as the device controller principal part 202. It is noted that the storage device may be omitted from the device controller principal part 202, and the firmware may be stored in the NAND memory 210. The device controller principal part 202 can be configured using an ASIC (Application Specific Integrated Circuit).

The memory system 2 of the first embodiment assumes the flash memory for the embedded application, which is compliant with the UFS (Universal Flash Storage) standard. For this reason, commands and the like to be described below follow the UFS standard.

<Overview of Host Device>

The host device 1 comprises a CPU 110 which executes the OS or user program, a main memory 100, and a host controller 120. The main memory 100, CPU 110, and host controller 120 are connected to each other by a bus 140.

The main memory 100 is configured by, for example, a DRAM. The main memory 100 includes a host use area 101 and a device use area 102. The host use area 101 is used as a program expansion area when the host device 1 executes the OS or user program, and is used as a work area when the host device 1 executes the program expanded on the program expansion area. The device use area 102 is used as a cache area of the management information of the memory system 2, or a cache area for read/write accesses. In the first embodiment, and second to fourth embodiments to be described later, the L2P table 211 is taken as an example of the management information cached on the device use area 102. Also, it is assumed that the write data is cached on the device use area 102.

<Overview of Port>

Next, respective ports of the host device 1 and memory system 2 of the first embodiment will be described. The host device 1 and memory system 2 of the first embodiment are connected by a single line (communication path 3) physically, but they are connected by a plurality of access points called ports (to be also referred to as “CPort” hereinafter) to be described below.

The host controller 120 comprises a bus adapter 121, a device connection adapter 126, and a host controller principal part 122. The bus adapter 121 is a connection interface of the bus 140. The device connection adapter 126 is a connection interface of the communication path 3. The host controller principal part 122 performs transfer of data or command with the main memory 100 or CPU 110 via the bus adapter 121, and performs transfer of data (including command) with the memory system 2 via the device connection adapter 126. The host controller principal part 122 is connected to the device connection adapter 126 by a first port 130, and can execute data transfer with the memory system 2 via the first port 130.

Moreover, the host controller 120 comprises a main memory DMA (Direct Memory Access) 123, control DMA 124, and data DMA 125. The main memory DMA 123 executes DMA transfer between the host use area 101 and device use area 102. The control DMA 124 captures a command transmitted by the memory system 2 for accessing the device use area 102, and the host controller principal part 122 transmits status information relating to the device use area 102 to the memory system 2. The data DMA 125 executes DMA transfer with the device use area 102, and is used to exchange data between the memory system 2 and device use area 102.

The control DMA 124 is connected to the device connection adapter 126 by a second port 131, and can exchange commands or status information with the memory system 2 via the second port 131. Also, the data DMA 125 is connected to the device connection adapter 126 by a third port 132, and can exchange data with the memory system 2 via the third port 132.

It is noted that the first port 130 is associated with the first port 230, the second port 131 is associated with the second port 231, and the third port 132 is associated with the third port 232 by functions of the device connection adapter 126 and the host connection adapter 201. More specifically, the host connection adapter 201 sends, the content sent to the memory system 2 via the first port 130, to the device controller principal part 202 via the first port 230. Likewise, the host connection adapter 201 sends, the content sent to the memory system 2 via the second port 131, to the device controller principal part 202 via the second port 231. The host connection adapter 201 sends, the content sent to the memory system 2 via the third port 132, to the device controller principal part 202 via the third port 232.

Moreover, the device connection adapter 126 sends, the content sent to the host device 1 via the first port 230, to the host controller principal part 122 via the first port 130. Likewise, the device connection adapter 126 sends, the content sent to the host device 1 via the second port 231, to the control DMA 124 via the second port 131. The device connection adapter 126 sends, the content sent to the host device 1 via the third port 232 to the data DMA 125 via the third port 132. The content sent to the control DMA 124 and data DMA 125 is sent to the host controller principal part 122 via, for example, the bus adapter 121.

It is noted that each of the ports 130 to 132 may independently include an input buffer used for communication with the memory system 2. Since the host controller principal part 122, control DMA 124, and data DMA 125 are connected to the memory system 2 using different input/output buffers respectively, the host controller 120 can independently execute communication with the memory system 2 using the host controller principal part 122, communication with the memory system 2 using the control DMA 124, and communication with the memory system 2 using the data DMA 125, respectively. In addition, since these communications can be switched without requiring any replacements of the input/output buffers, switching of the communications can be executed at high speed. The same applies to the ports 230 to 232 included in the memory system 2.

As described above, the information processing device of the first embodiment comprises three types of ports which are the first ports (to be also referred to as “CPort 0” hereinafter) 130 and 230, the second ports (to be also referred to as “CPort 1” hereinafter) 131 and 231, and the third ports (to be also referred to as “CPort 2” hereinafter) 132 and 232.

In addition, priorities (to be also referred to as “TC” or the like hereinafter) are defined in advance for the respective ports. More specifically, a priority “0 (low)” is set for the first ports 130 and 230, a priority “1 (high)” is set for the second ports 131 and 231, and priority “0 (low)” is set for the third ports 132 and 232. The priority means a priority order when data or the like is returned from the host device 1 to the memory system 2. More specifically, the priority is a value which defines data transfer order or the like when a data transfer contention or the like between the host device 1 and the memory system 2 has occurred.

The first ports 130 and 230 are basically used only at the time of demanding from the host device 1 to the memory system 2. The second ports 131 and 231 and third ports 132 and 232 are appropriately selected by a request from the memory system 2, as will be described later.

It is noted that when the first ports 130 and 230 need not be distinguished from each other, they will be simply referred to as “first port” for the sake of simplicity. Also, when the second ports 131 and 231 need not be distinguished from each other, they will be simply referred to as “second port” for the sake of simplicity. Furthermore, when the third ports 132 and 232 need not be distinguished from each other, they will be simply referred to as “third port” for the sake of simplicity.

<Memory Structure of Device Use Area>

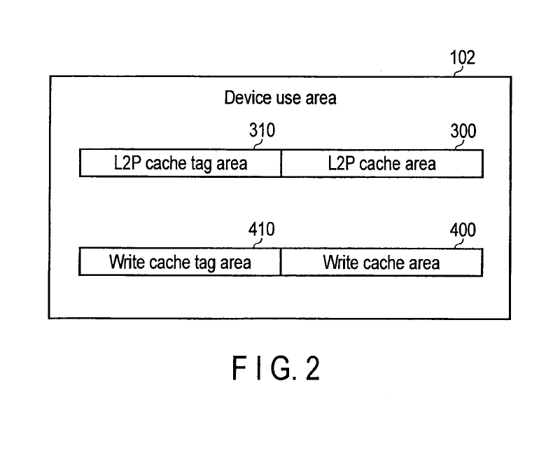

FIG. 2 shows the memory structure of the device use area 102. As illustrated in the figure, the device use area 102 comprises an L2P cache area 300, L2P cache tag area 310, write cache area 400, and write cache tag area 410.

The L2P cache tag area 310 and the L2P cache area 300 are continuously allocated on physical addresses in the device use area 102. The write cache tag area 410 and the write cache area 400 are continuously allocated on physical addresses in the device use area 102.

The L2P cache area 300 caches a part of the L2P body 211. The part of the L2P body 211 cached on the L2P cache area 300 will be referred to as an L2P table cache hereinafter. The L2P cache tag area 310 stores tag information used in hit/miss determination of the L2P cache area 300. The tag information is corresponded with each L2P table cache. The tag information includes information relating to the corresponded L2P table cache, and is used to identify it.

The write cache area 400 is a memory area having a cache structure which buffers write data. The write cache tag area 410 stores tag information used in hit/miss determination of the write cache area 400.

<Memory Structure of L2P Cache Area and Tag Area>

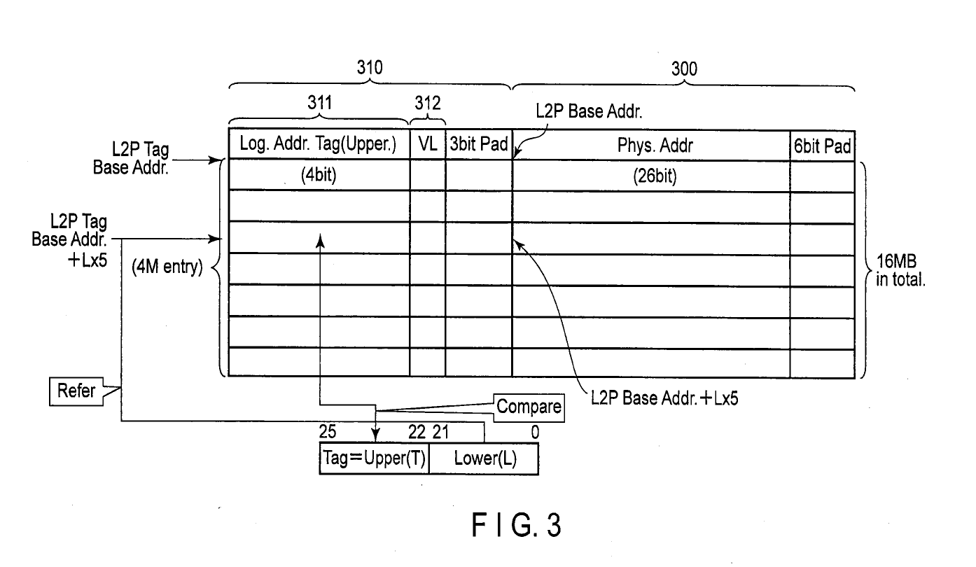

FIG. 3 shows the memory structure of the L2P cache tag area 310 and L2P cache area 300 in the device use area 102.

As illustrated in the figure, the L2P cache tag area 310 and the L2P cache area 300 are allocated on continuous physical addresses in the device use area 102, as described above. In the device use area 102, L2P tag information in the L2P cache tag area 310 is allocated, and L2P table caches in the L2P cache area 300 are allocated to be continuous with the end of the L2P tag information. Here, “continuous” means that another data (another L2P tag information or L2P table cache) is not allocated between the L2P tag information and the L2P table cache.

More specifically, an uppermost line of the L2P cache tag area 310 and L2P cache area 300 shown in FIG. 3 is an item name. A first cache line below the item name stores L2P tag information at the head, and stores an L2P table cache to be continuous with the end of the L2P tag information. Furthermore, a second or subsequent cache line similarly stores L2P tag information at the head, and stores an L2P table cache to be continuous with the end of the L2P tag information. The L2P tag information and L2P table cache of each individual cache line are continuously stored on physical addresses. The L2P tag information corresponds to the L2P table cache stored in the identical cache line.

Assume that, for example, an LBA has a data length of 26 bits, and the L2P cache area 300 is referred using a value of lower 22 bits of the LBA. In the following description, let T be a value of upper 4 bits of the LBA, and L be a value of the lower 22 bits. It is noted that the LBA is assumed to be allocated for each page (here, 4 Kbytes) which configures the NAND memory 210.

Each individual cache line which configures the L2P cache area 300 stores a physical address (Phys. Addr.) for one LBA, as shown in FIG. 3. That is, the L2P cache area 300 is configured to store physical addresses corresponding to LBAs in the order of L values. The L2P cache area 300 is configured by cache lines as many as the number obtained by raising 2 to the 22nd power. Each individual cache line has a capacity of 4 bytes as a sufficient size required to store a 26 bit physical address. Therefore, the L2P cache area 300 has a total size obtained by multiplying 2²² by 4 bytes, that is, 16 Mbytes. Also, each individual cache line of the L2P cache tag area 310 has a capacity of 1 byte.

Each individual cache line which configures the L2P cache area 300 and L2P cache tag area 310 is read by referring to an address obtained by adding a base address (L2P Base Addr.) of the L2P cache area 300 to 5*L. It is note that of each 4 byte cache line which configures the L2P cache area 300, a surplus area excluding an area which stores a 26 bit physical address is described as “Pad”. In the subsequent tables, a surplus portion will also be described as “Pad”.

In addition, as shown in FIG. 3, the L2P cache tag area 310 is configured to register values T as tag information for each cache lines stored in the L2P cache area 300 in an order of L values. Each individual entry includes a field 311 which stores tag information, and a field 312 which stores a VL (Valid L2P) bit indicating a valid cache line or not. Here, although the L2P cache tag area 310 is registered in the L2P cache tag area 310 as the tag information, it is configured to be matched with the upper digits T of the LBA corresponding to the physical address stored in cache line corresponding to the L2P cache area 300. That is, whether or not the physical address corresponding to upper digits T of a desired LBA is cached on the L2P cache area 300 is determined by multiplying an L value constituting the desired LBA by 5, referring to an address added with a base address (L2P Tag Base Addr.) of the L2P cache tag area 310, determining whether or not the tag information stored at the referred location matches a T value constituting the desired LBA. When the both match, it is determined that the physical address corresponding to the desired LBA is cached, when the both do not match, it is determined that the physical address corresponding to the desired LBA is not cached. It is noted that since T is a 4 bit value and the VL bit requires 1 bit size, each individual entry has a capacity of 1 byte. Therefore, the L2P cache tag area 310 has a size obtained by multiplying 2²² by 1 byte, that is, 4 Mbytes.

<Memory Structure of Write Cache Area and Tag Area>

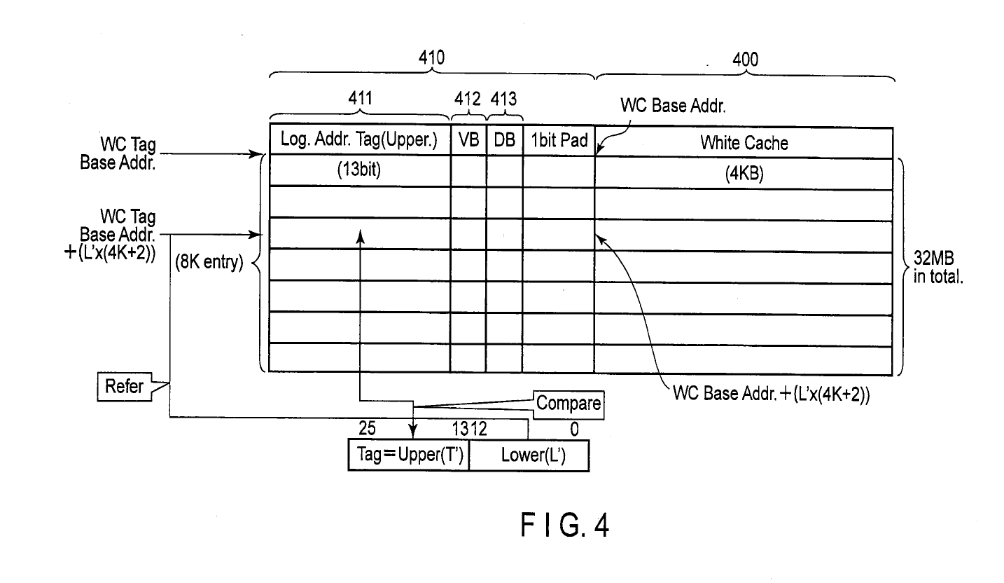

FIG. 4 shows the memory structure of the write cache tag area 410 and write cache area 400 in the device use area 102.

As illustrated in the figure, the write cache tag area 410 and write cache area 400 are allocated on continuous physical addresses in the device use area 102, as described above. In the device use area 102, write tag information in the write cache tag area 410 is allocated, and a write cache in the write cache area 400 is allocated to be continuous with the end of the write tag information. It is noted that “continuous” means that another data (another write tag information or write cache) is not allocated between the write tag information and write cache.

In detail, an uppermost line of the write cache tag area 410 and write cache area 400 shown in FIG. 4 is an item name. A first cache line below the item names stores the write tag information at the head, and stores the write cache to be continuous with the end of the write tag information. Furthermore, a second or subsequent cache line similarly stores write tag information at the head, and stores a write cache to be continuous with the end of the write tag information. The write tag information and write cache of each individual cache line are continuously stored on physical addresses. The write tag information corresponds to the write cache stored in the identical cache line.

Here, it is assumed that the write cache area 400 is referred using a value of lower 13 bits of the LBA. In the following description, let T′ be a value of upper 13 bits of the LBA, and L′ be a value of lower 13 bits.

Each individual cache line constituting the write cache area 400 stores write data of a page size, as shown in FIG. 4. That is, the write cache area 400 stores corresponding write data in an order of L′ values.

The write cache area 400 is configured by cache lines as many as the number obtained by raising 2 to the 13th power. Since each cache line caches write data of a page size (4 Kbytes in this case), the write cache area 400 has a total size obtained by multiplying 2¹³ by 4 Kbytes, that is, 32 Mbytes. Also, each individual cache line of the write cache tag area 410 has a capacity of 2 bytes.

Each individual cache line constituting the write cache area 400 and write cache tag area 410 is read by referring to an address obtained by adding a base address (WC Base Addr.) of the write cache area 400 to L′*(4K+2).

In addition, as shown in FIG. 4, the write cache tag area 410 is configured to register T′ as tag information for each cache line stored in the write cache area 400 in an order of L′. Each individual entry has fields 411, 412, and 413. The field 411 stores tag information. The field 412 stores a VB (Valid Buffer) bit indicating a valid cache line or not. The field 413 stores a DB (Dirty Buffer) bit indicating whether cached write data is dirty or clean.

Although, the write cache tag area 410 is registered in the write cache tag area 410 as the tag information, it is configured to be matched with upper digits T′ of the LBA allocated to a storage destination page of write data stored in a corresponding cache line (that is, a cache line referred to using L′) of the write cache area 400. That is, whether or not the write data corresponding to the desired LBA is cached in the write cache area 400 is determined by multiplying an L′ value constituting upper digits T of the desired LBA by a sum value of 2 and 4K which is a size of the corresponding write cache data, referring to an address added with a base address (WC Tag Base Addr.) of the write cache tag area 410, determining whether or not the tag information stored at the referred location matches a T′ value constituting the desired LBA.

It is noted that the cache line being dirty means a state in which write data stored in that cache line does not match data stored at a corresponding address on the NAND memory 210, and the cache line being clean means a state in which the both match. When a dirty cache line is written back to the NAND memory 210, the cache line becomes clean. It is noted that since each individual tag information T′ of the write cache tag area 410 has a data length of 13 bits, and each of the DB bit and VB bit requires a 1 bit size, each individual entry has a capacity of 2 bytes. Therefore, the write cache tag area 410 has a size obtained by multiplying 2¹³ by 2 bytes, that is, a size of 16 Kbytes.

The CPU 110 executes the OS and user programs, and generates a write command for writing data in the host use area 101 in the memory system 2 based on a request from each of these programs. The generated write command is sent to the host controller 120.

<Overview of Data Structure of Write Command>

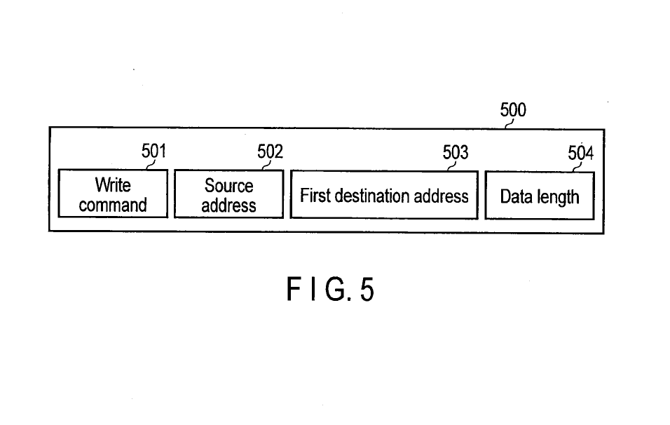

FIG. 5 shows a data structure example of the write command.

As illustrated in the figure, a write command 500 is configured to include a write command 501, source address 502, a first destination address 503, and data length 504.

The write command 501 indicates that the write command 500 commands to write data. The source address 502 is an address in the host use area 101 at which write target data is stored. The first destination address 503 indicates a write destination address of the write data, and is described by an LBA. The data length 504 indicates a data length of the write data. The host controller principal part 122 receives the write command 500 which is sent from the CPU 110 via the bus adapter 121. Furthermore, the host controller principal part 122 reads the source address 502 and first destination address 503 included in the received write command 500. Then, the host controller principal part 122 transfers data stored at the source address 502 and the first destination address 503 to the memory system 2 via the device connection adapter 126.

It is noted that when the host controller principal part 122 loads data stored at the source address 502, it may use the main memory DMA 123. On this occasion, the host controller principal part 122 sets the source address 502, data length 504, and destination address at a buffer address in the host controller principal part 122, and activates the main memory DMA 123.

Also, the host controller principal part 122 can receive various commands from the CPU 110 in addition to the write command 500. Here, the host controller principal part 122 enqueues received commands in a command queue, and takes out commands of the processing object in order from the head of the command queue. It is noted that the area for storing the data structure of this command queue may be secured in the main memory 100, or the area may be provided in a small scale memory or register which is disposed inside or in the vicinity of the host controller principal part 122.

Furthermore, a communication route between the host controller principal part 122, main memory DMA 123, control DMA 124, and data DMA 125 is not limited to a specific route. For example, the bus adapter 121 may be used as a communication route, or a dedicated line may be arranged to be used as a communication route.

<About Format of Command>

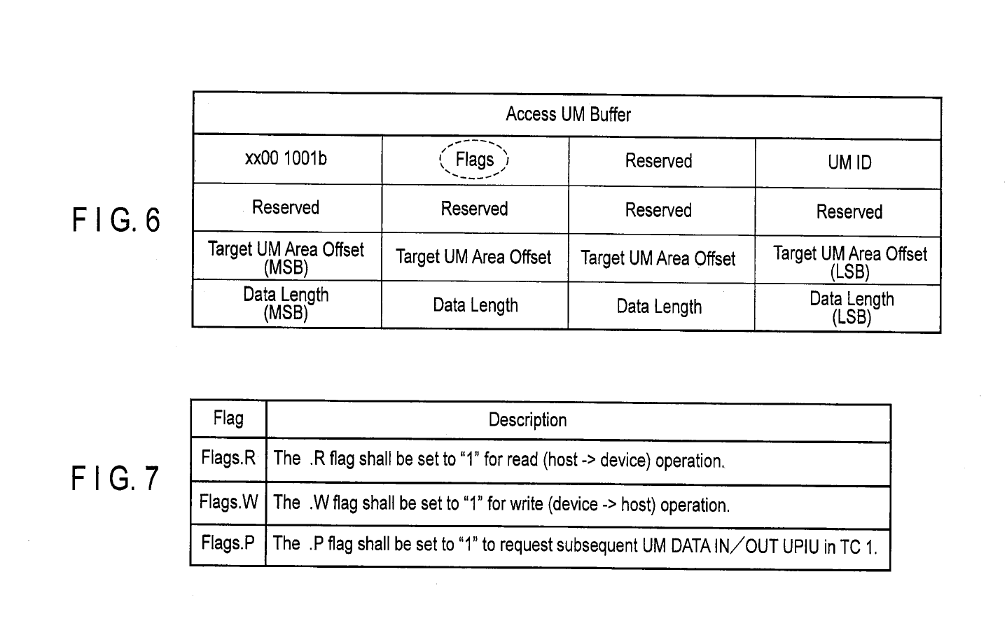

Next, a format of the data transfer command according to the first embodiment will be described with reference to FIG. 6. FIG. 6 shows an example of the format of the data transfer command according to the first embodiment.

As shown in FIG. 6, the data transfer command (Access UM Buffer) can include various kinds of information at the time of performing data transfer with the host device 1. The data transfer command (Access UM Buffer) according to the first embodiment can especially include “Flags” information (refer to broken line portion inside in the figure).

<About Flags>

The Flags included in the data transfer command (Access UM Buffer) according to the first embodiment will be described with reference to FIG. 7. FIG. 7 shows an example of the flags included in the data transfer command (Access UM Buffer) according to the first embodiment.

As shown in FIG. 7, the Flags included in the data transfer command (Access UM Buffer) according to the first embodiment exist three types of flags which are a flag R (Flags.R), flag W (Flags.W), and flag P (Flags.P). The memory system 2 sets these flags of the data transfer command (Access UM Buffer).

[Flag R (Flags.R)]

The flag R indicates that a subsequent operation is an operation for reading data from the data use area 102 of the host device 1 to the memory system 2.

More specifically, in a case of the data read operation from the host device 1 to the memory system 2, “1” is set in the flag R.

[Flag W (Flags.W)]

The flag W indicates that a subsequent operation is an operation for writing data in the device use area 102 of the host device 1 from the memory system 2.

In a case of the data write operation from the memory system 2 to the host device 1, “1” is set in the flag W.

[Flag P (Flags.P)]

The flag P is a flag for determining the priority of a subsequent data input sequence from the memory system 2 to the host device 1 (UM DATA IN) or data output sequence from the host device 1 to the memory system 2 (UM DATA IN). Each sequence is executed via a port corresponding to the selected priority. It is noted that a description about the priority determined based on the flag P will not be given.

Next, an operation of the memory system according to the first embodiment will be described. The first embodiment will explain an example in which the L2P cache tag area 310 and L2P cache area 300 are allocated at continuous physical addresses in the device use area 102, and an L2P table cache and L2P tag information are read at a time by single sequence control using the data transfer command. This first embodiment uses a direct map method as a data allocation in the device use area 102 as a cache memory.

<Write Operation>

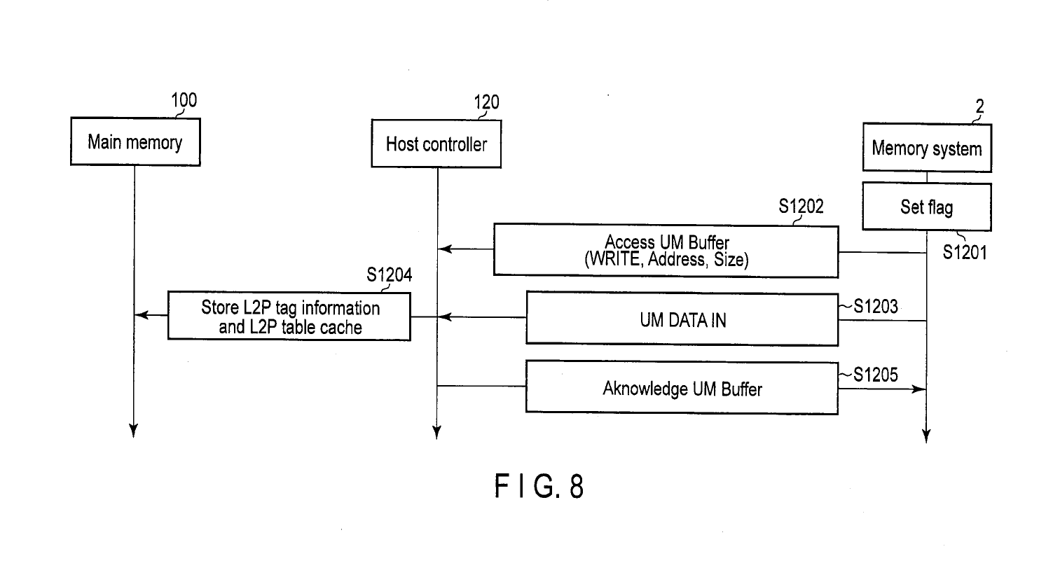

With reference to FIG. 8, an operation example of the information processing device in a case that the memory system 2 writes the L2P tag information and the L2P table cache in the host device 1 will be described. FIG. 8 is a view showing an operation of the transmitting L2P tag information and the L2P table cache by the memory system 2.

[Step S1201]

In order to write the L2P tag information and the L2P table cache in the host device 1, the device controller 200 sets “1” in the flag W in a data transfer command (Access UM Buffer). The data transfer command is a command for writing write data in the device use area 102.

[Step S1202]

The device controller 200 transmits a data transfer command (Access UM Buffer) including information such as [flag W=“1”, address, and size (WRITE, Address, Size)] to the host device 1. The physical address in the device use area 102 for writing the L2P tag information and the L2P table cache is set in the address. The size is set to the sum of the L2P tag information and the L2P table cache.

[Step S1203]

The device controller 200 transmits the command (UM DATA IN) for transmitting the L2P tag information and the L2P table cache to the host device 1.

In response to receiving the command (Access UM Buffer) from the memory system 2, which commands data writing, the host controller 120 receives the L2P tag information and the L2P table cache from the memory system 2 based on the information such as [flag W=“1”, address, and size (WRITE, Address, Size)] (UM DATA IN).

[Step S1204]

The host controller 120 stores the L2P tag information and the L2P table cache received from the memory system 2 on continuous physical addresses in the device use area 102. That is, the host controller 120 writes the L2P tag information and the L2P table cache in one cache line shown in FIG. 3.

[Step S1205]

After the L2P tag information and L2P table cache are stored in the device use area 102, the host controller 120 transmits an acknowledge command (Acknowledge UM Buffer) which means completion to the memory system 2. Thereby, the write operation of the L2P tag information and the L2P table cache from the memory system 2 to the host device 1 is complete.

<Read Operation>

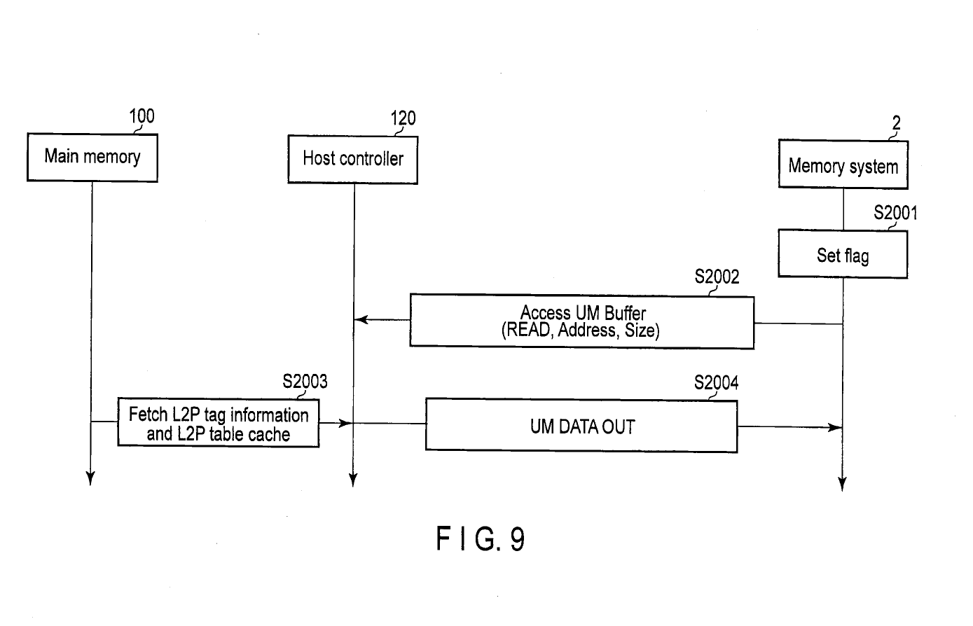

With reference to FIG. 9, an operation example of the information processing device in a case that the memory system 2 reads the L2P tag information and the L2P table cache from the host device 1 will be described. FIG. 9 shows an operation executed when the memory system 2 reads L2P tag information and an L2P table cache. FIG. 9 is a view showing the operation of reading the L2P tag information and the L2P table cache by the memory system.

[Step S2001]

The device controller principal part 202 sets “1” in the flag R in the data transfer command (Access UM Buffer) so as to the read L2P tag information and the L2P table cache from the host device 1.

[Step S2002]

The device controller principal part 202 transmits the data transfer command (Access UM Buffer) to the host device 1. The data transfer command (Access UM Buffer) includes information such as [flag R=“1”, address, and size (READ, Address, Size)]. A head physical address of an area which stores the L2P tag information and the 2-way L2P table caches in the device use area 102 is set at the address. The size is set to the sum of the L2P tag information and the L2P table cache.

[Step S2003]

In response to receiving the data transfer command (Access UM Buffer) from the memory system 2, the host controller 120 fetches the L2P tag information and the L2P table cache from the memory system 2 based on the information such as [flag R=“1”, address, and size (READ, Address, Size)].

[Step S2004]

And the host controller 120 transfers the L2P tag information and the L2P table cache to the memory system 2 (UM DATA OUT).

According to the first embodiment, the L2P tag information and the L2P table cache can be read from the device use area 102 in the main memory 100 of the host device 1 to the memory system 2, by a single continuous read operation (read sequence control) by the data transfer command (Access UM Buffer).

Incidentally, in a memory system using the UMA, in a case of building a cache on the main memory of the host device, a data body of the cache, and a tag memory which holds information of tag and flags corresponding thereto are held on the main memory as in a normal cache. And this is commonly read from or written to firmware or hardware in the memory system for implementation.

In a case where the memory system reads or writes main memory from or to the host device, a bus bridge, a memory controller or the like of the host device are intermediated between the memory system and the main memory. For this reason, DMA (Direct Memory Access) transfer, packet communications or the like is required, thus generating a large overhead in their setup and transmission and reception processing of data.

In a case where the cache on the main memory of the host device is referred to, the memory system initially reads an entry corresponding to a key from the tag memory on the main memory. Furthermore, based on the content of the entry, validity of data is determined, and if the data is valid, a data body is read from the main memory. For this reason, even when the entry on the cache hits, two times of readout take place, thus deteriorating the cache effect.

Thus, as described above, according to the first embodiment, the L2P tag information and the L2P table cache can be read from the main memory 100 of the host device 1 to the memory system 2 by a single continuous read operation (read sequence control) by the data transfer command (Access UM Buffer), thus increasing the readout speed.

That is, the validity of the read L2P table cache is determined using the L2P tag information, that is, hit/miss the determination of the L2P table cache is executed, and when the L2P table cache is valid, the already read L2P table cache is used. For this reason, the L2P table cache need not be read from the device use area 102 again. Thereby, a time required to read the L2P table cache again can be reduced, and increasing the readout speed. This is more effective when hit rate of L2P table cache stored in the main memory 100 is high.

It is noted that the operations for writing and reading the write tag information and the write cache for the write cache tag area 410 and the write cache area 400 are nearly the same as the aforementioned operations for writing and reading the L2P tag information and the L2P table cache, and a description thereof will not be given. It is noted that since the hit rate of L2P table cache is generally higher than the hit rate of write cache, the effect of reading the L2P tag information and the L2P table cache at a time is higher than the effect of reading the write tag information and the write cache at a time.

A modification of the first embodiment will be described below.

This modification will explain an example in which the L2P cache area 300, the L2P cache tag area 310, the write cache area 400, and the write cache tag area 410 are independently allocated in the device use area 102, and the L2P tag information and the L2P table cache are read using a single command.

It is noted that the basic configuration and the basic operation of the memory system according to the modification are the same as those of the memory system according to the aforementioned first embodiment. Therefore, a description about the items which have been explained in the aforementioned first embodiment and those which can be easily analogized from the first embodiment will not be given.

<Memory Structure of Device Use Area>

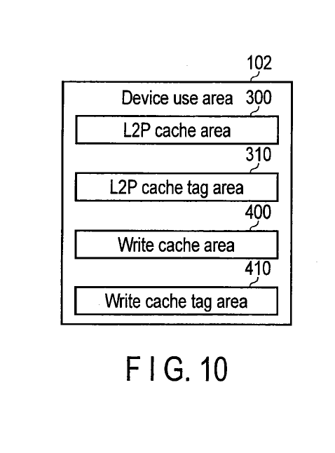

FIG. 10 is a view showing a memory structure of the device use area 120. As illustrated in figure, the L2P cache area 300, the L2P cache tag area 310, the write cache area 400, and the write tag area 410 are allocated without being continued on the device use area 102.

<Read Operation>

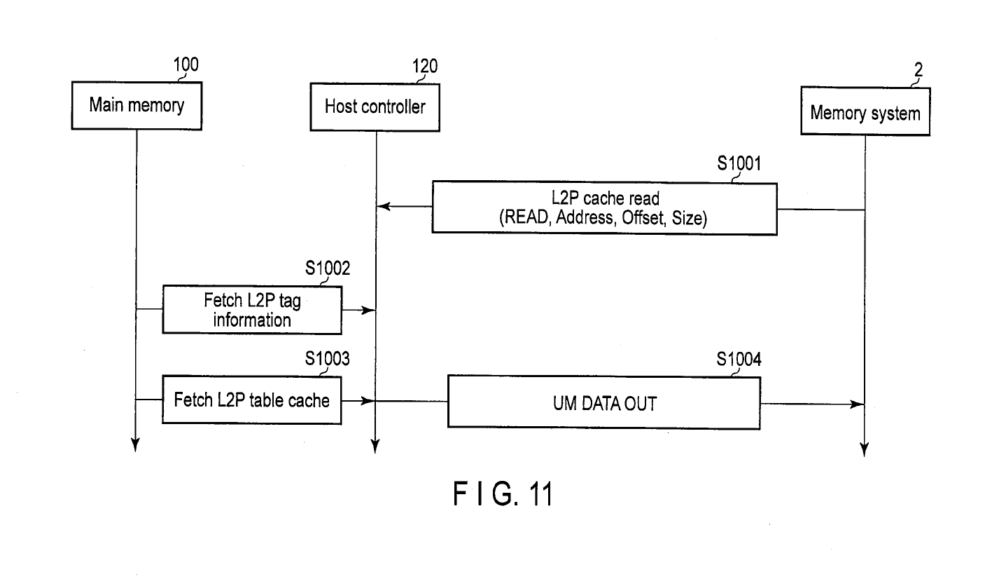

With reference to FIG. 11, an operation example of the information processing device in a case that the memory system 2 reads the L2P tag information and the L2P table cache from the host device 1 will be described. FIG. 9 shows an operation executed when the memory system 2 reads L2P tag information and an L2P table cache. FIG. 9 is a view showing the operation of reading the L2P tag information and the L2P table cache by the memory system.

[Step S1001]

The device controller principal part 202 transmits a command for reading the L2P tag information and the L2P table cache from the device use area 102 of the host device 1 (to be referred to as an L2P cache read hereinafter) to the host device 1. The L2P cache read includes information such as [READ, Address, Offset, Size]. For example, at the address, an address to generate addresses of the L2P tag information and the L2P table cache in the host controller 120 is set. The size is set to the sum of the L2P tag information and the L2P table cache.

[Steps S1002 and S1003]

In response to receiving the L2P cache read from the memory system 2, the host controller 120 fetches the L2P tag information and the L2P table cache respectively from the L2P cache area 300 and L2P cache tag area 310 in the device use area 102 based on the information such as [READ, Address, Offset, Size]. In detail, the host controller 120 generates an address of the L2P table cache in the L2P cache area 300, and an address of the L2P tag information in the L2P cache tag area 310 corresponding to the L2P table cache based on the address received from the memory system 2. And the host controller 120 reads the L2P table cache and the L2P tag information from the L2P cache area 300 and the L2P cache tag area 310 based on the generated addresses of the L2P table cache and the L2P tag information.

[Step S1004]

And, the host controller 120 transfers the L2P tag information and the L2P table cache to the memory system 2 (UM DATA OUT).

In the modification, L2P tag information and the L2P table cache can be read from the device use area 102 in the main memory 100 of the host device 1 to the memory system 2 by a single continuous read operation (read sequence control) by the L2P cache read.

The validity of the read L2P table cache is determined using the L2P tag information, that is, hit/miss the determination of the L2P table cache is executed, and when the L2P table cache is valid, the already read L2P table cache is used. For this reason, the L2P table cache need not be read from the device use area 102 again. Thereby, a time required to read the L2P table cache again can be reduced, and increasing the readout speed. This is more effective when hit rate of L2P table cache stored in the main memory 100 is high.

It is noted that operations for reading the write tag information and the write cache from the write cache tag area 410 and the write cache area 400 are nearly the same as the aforementioned operations for reading the L2P tag information and the L2P table cache, and the description thereof has been omitted. It is noted that since the L2P table cache hit rate is higher than the write cache hit rate, the effect of reading the L2P tag information and the L2P table cache at a time is higher than the effect of reading the write tag information and the write cache at a time.

### Second Embodiment

Next, an operation of a memory system according to the second embodiment will be described. The second embodiment will explain an example in which the L2P cache tag area 310 and plural way L2P cache areas 300 are continuously allocated on addresses in the device use area 102, and the L2P tag information and the L2P table cache are read at a time by a single sequence control by the data transfer command. The second embodiment uses a set associative method as a data allocation in the device use area 102 as a cache memory.

It is noted that the basic configuration and the basic operation of the memory system according to the second embodiment are the same as those of the memory system according to the aforementioned first embodiment. Therefore, a description about the items which have been explained in the aforementioned first embodiment and those which can be easily analogized from the first embodiment will not be given.

<Memory Structure of Device Use Area>

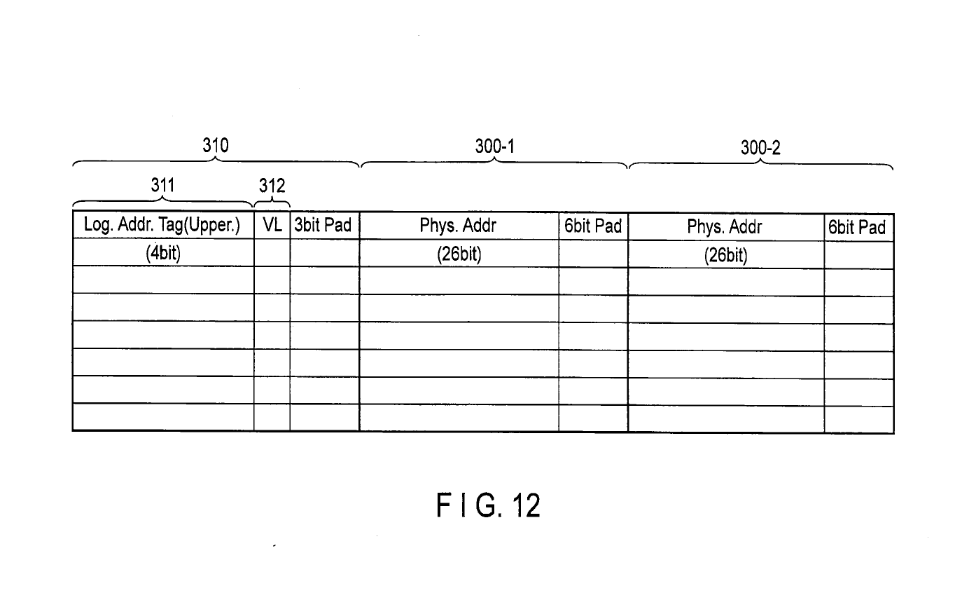

FIG. 12 is a view showing a memory structure of the L2P cache tag area 310 and the L2P cache area 300 in the device use area 102 according to the second embodiment. It is noted that a description of the write cache area 400 and write cache tag area 410 has been omitted.

As illustrated in the figure, the L2P cache tag area 310, and a cache area (first field) 300-1 L2P and L2P cache area (second field) 300-2 of 2 way are stored at continuous physical addresses in the device use area 102. The L2P tag information in the L2P cache tag area 310 is allocated in the device use area 102, and the L2P table caches in the L2P cache areas 300-1, 300-2 are allocated to be continuous with the end of the L2P tag information. Here, “continuous” means that another data (another L2P tag information or L2P table cache) is not allocated between the L2P tag information and the L2P table cache and between the L2P table caches.

More specifically, an uppermost line of the L2P cache tag area 310 and the L2P cache areas 300-1 and 300-2 shown in FIG. 12 includes item names. A first cache line below the item names stores the L2P tag information at the head, and stores the L2P table caches to be continuous with the end of the L2P tag information. Furthermore, a second or subsequent cache line similarly stores the L2P tag information at the head, and stores the L2P table caches to be continuous with the end of the L2P tag information. The L2P tag information and the L2P table caches of each individual cache line are continuously stored on physical addresses. The L2P tag information corresponds to the L2P table caches stored in the same cache line.

Here, although the L2P cache areas 300-1, 300-2 of 2 way is described, areas of 3 or more way may be arranged. The set associative method is a method in which a certain data block (for example, a cache area) is allocated only within a predetermined range in the device use area. The device use area is divided into a plurality of sets, and the way indicates how many data blocks constitute the each of the sets.

Details of the L2P cache tag area 310 and the L2P cache areas 300-1 and 300-2 are described in FIG. 3, and the description thereof will not be repeated.

<Read Operation>

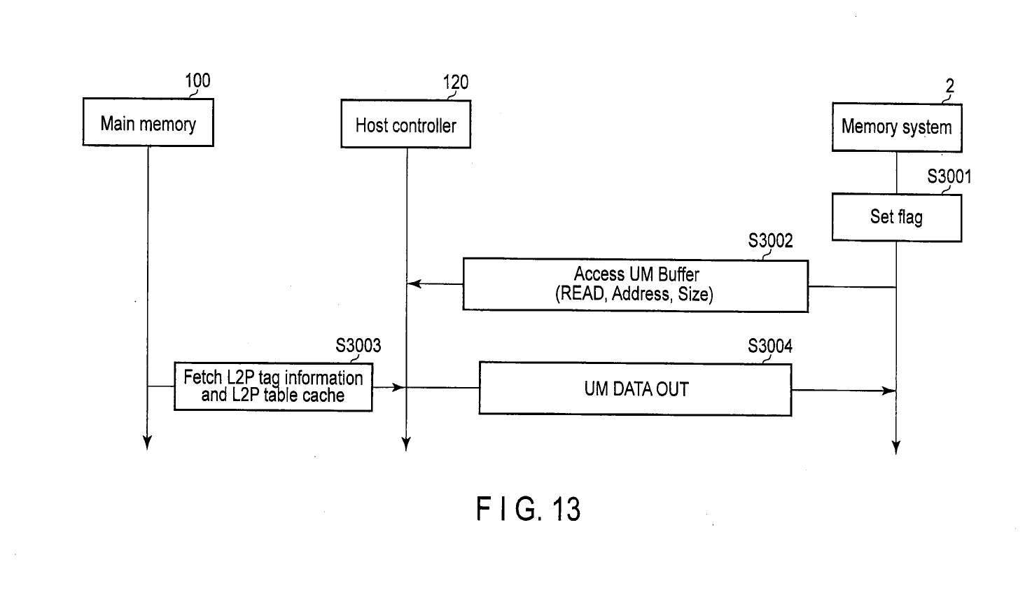

Next, with reference to FIG. 13, an operation example of the information processing device in a case that the memory system 2 reads the L2P tag information and the L2P table caches from the host device 1 will be described. FIG. 13 is a view showing the operation of reading the L2P tag information and the L2P table cache.

[Step S3001]

A device controller principal part 202 sets “1” in the flag R in the data transfer command (Access UM Buffer) so as to read the L2P tag information and the L2P table caches from the host device 1.

[Step S3002]

The device controller principal part 202 transmits the data transfer command (Access UM Buffer) to the host device 1. The data transfer command (Access UM Buffer) includes information such as [flag R=“1”, address, and size (READ, Address, Size)]. A head physical address of an area which stores the L2P tag information and the 2-way L2P table caches in the device use area 102 is set at the address. The size is set to the sum of the L2P tag information and the L2P table cache.

[Step S3003]

In response to receiving the data transfer command (Access UM Buffer) from the memory system 2, the host controller 120 fetches the L2P tag information and the 2-way L2P table caches from the device use area 102, based on the information such as [flag R=“1”, address, and size (READ, Address, Size)].

[Step S3004]

And the host controller 120 transfers the L2P tag information and the 2-way L2P table caches to the memory system 2 (UM DATA OUT).

In the second embodiment, the L2P tag information and the 2-way L2P table caches can be read from the device use area 102 in the main memory 100 of the host device 1 to the memory system 2, by a single continuous read operation (read sequence control) by the data transfer command (Access UM Buffer).

The validity of the read L2P table caches is determined using the L2P tag information, that is, hit/miss determination of the L2P table caches is executed, and when the L2P table caches are valid, the already read L2P table caches are used. For this reason, the L2P table caches need not be read from the device use area 102 again. Thereby, a time required to read the L2P table caches again can be reduced, thus increasing the read speed. This is more effective when the hit rate of L2P table cache stored in the main memory 100 is high.

It is noted that operations for reading the write tag information and the write cache from the write cache tag area 410 and the write cache area 400 are nearly the same as the aforementioned operations for reading the L2P tag information and the L2P table caches, and the description thereof has been omitted. It is noted that since the L2P table cache hit rate is generally higher than the write cache hit rate, the effect of reading L2P tag information and the L2P table cache at a time is higher than the effect of reading the write tag information and the write cache at once.

### Third Embodiment

Next, an operation of a memory system according to the third embodiment will be described. The third embodiment will explain an example in which the L2P cache tag area 310 is allocated in the RAM 203 of the memory system 2, and the L2P cache area 300 is allocated in the device use area 102 of the memory device 1.

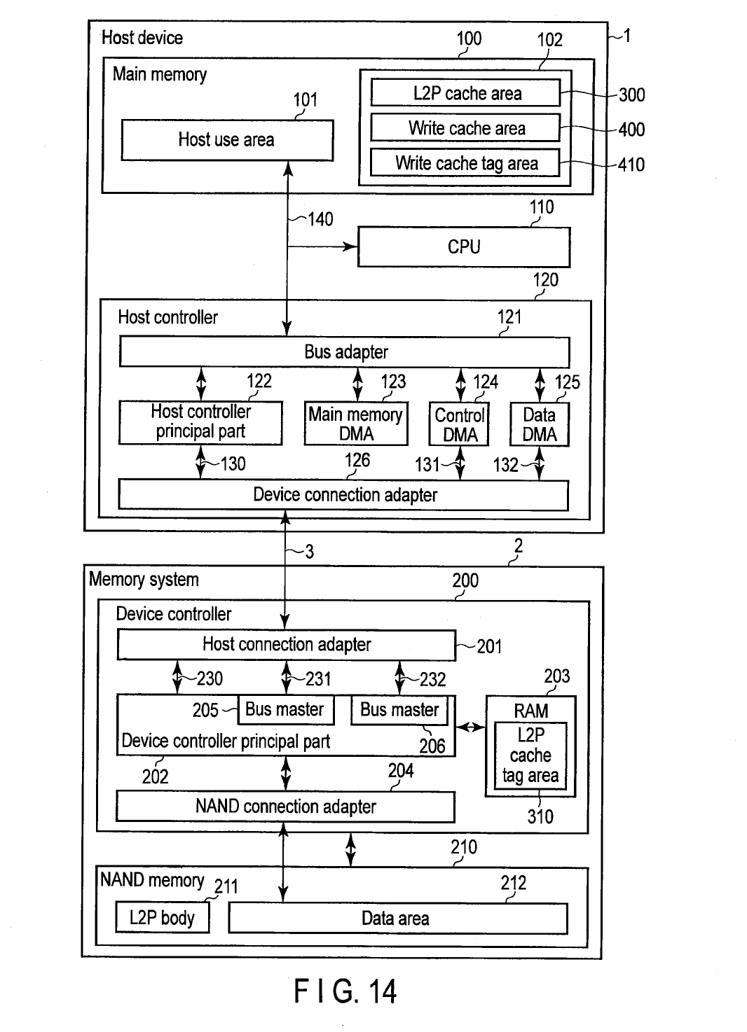

FIG. 14 is a block diagram schematically showing a configuration of an information processing device according to the third embodiment.

As illustrated in the figure, the L2P cache area 300, the write cache area 400, and the write cache tag area 410 are allocated in the device use area 102 in the main memory 100 of the host device 1. The detail of the L2P cache area 300 has been shown in FIG. 3, and the details of the write cache area 400 and the write cache tag area 410 have been shown in FIG. 4, then the description thereof will be omitted.

The L2P cache tag area 310 is allocated in the RAM 203 in the device controller 200 of the memory system 2. Details of the L2P cache tag area 310 have been shown in FIG. 3, then the description thereof will be omitted.

Other basic configurations and operations of the memory system of the third embodiment are the same as those of the memory system of the aforementioned first embodiment. Therefore, the description about the items explained in the aforementioned first embodiment and those which can be easily analogized from the first embodiment will be omitted.

<Read Operation>

The memory system 2 reads the L2P tag information from the L2P cache tag area 310 in the RAM 203. The memory system 2 compares the L2P tag information with a key, and if the L2P tag information hits the key, then the L2P table cache is read from the L2P cache area 300 in the device use area 102 of the host device 1, according to the following operation.

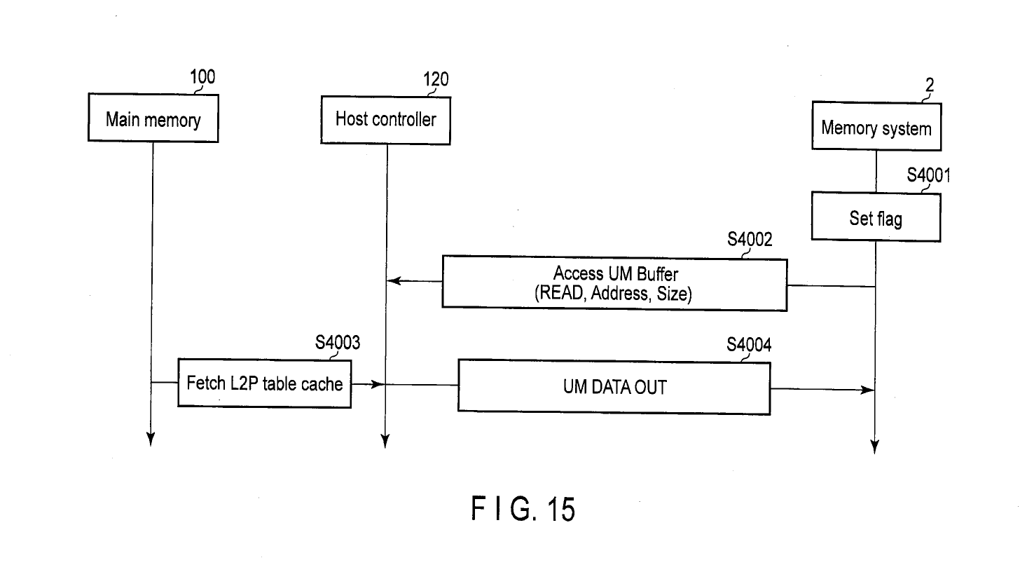

FIG. 15 is a view showing the operation of reading the L2P table from the host device 1 cache by the memory system.

[Step S4001]

The device controller principal part 202 sets “1” in the flag R in the data transfer command (Access UM Buffer) so as to read the L2P table cache from the device use area 102 of the host device 1.

[Step S4002]

The device controller principal part 202 transmits the data transfer command (Access UM Buffer) to the host device 1. The data transfer command (Access UM Buffer) includes information such as [flag R=“1”, address, and size (READ, Address, Size)]. A physical address at which the L2P table cache in the device use area 102 is stored is set at the address. The size is set to a size including the L2P table cache.

[Step S4003]

In response to receiving the data transfer command (Access UM Buffer) from the memory system 2, the host controller 120 fetches the L2P table cache from the device use area 102 based on the information such as [flag R=“1”, address, and size (READ, Address, Size)].

[Step S4004]

And the host controller 120 transfers the L2P table cache to the memory system 2 (UM DATA OUT).

In the third embodiment, the L2P tag information is read from the RAM 203 of the memory system 2, and the L2P table cache is read from the device use area 102 of the host device 1 to the memory system 2, by a read operation (read sequence control) by the data transfer command (Access UM Buffer).

Since the acquisition of the L2P table cache at the time of writing or reading is executed in a single read operation (read sequence control), the time required for the writing or the reading is decreased. This is more effective when hit rate of the L2P table cache stored in the main memory 100 is high.

There is a case that the capacity of reception buffer for receiving the transfer data in the memory system 2 may limit a data size to be transferred from the host device 1. In the third embodiment, the reception buffer of the memory system 2 need only have a capacity enough to store a data size of a management unit (transfer unit) of the L2P table cache. The reception buffer generally has a storage capacity of the power of 2. For example, in the first and second embodiments, when the reception buffer has a capacity of 512 bytes, the management unit of the L2P table cache is 512 bytes, and its L2P tag information is a few bytes, the L2P table cache and the L2P tag information cannot be transferred at a time. In this case, the capacity of the reception buffer has to be increased, or the management unit of the L2P table cache has to be decreased. However, in the third embodiment, since only the table cache need for the transfer from the host device 1 to the reception buffer of the memory system 2, the trouble does not occur.

In the aforementioned first to third embodiments, the L2P table and the corresponding L2P tag information have been described, however it is not limited to this, and the first to third embodiments are similarly applicable to other data and the corresponding tag information.

In addition, in the aforementioned embodiments, the description has been given using the UFS memory device, however it is not limited to this, and is applicable to other memory devices as long as they use data and the corresponding tag information.

Furthermore, in the first to third embodiments, the description has been given with a used of the UFS memory device, however they are applicable to other memory card, internal memory or the like as long as the semiconductor storage device operates similarly, and the same effects as in the aforementioned embodiments can be obtained. Moreover, the NAND flash memory 210 is not limited to this, but it may be other semiconductor memory.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing device comprising:
a host device comprising:
a first memory portion configured to store first data and tag information corresponding to the first data; and
a host controller configured to control input and output of data for the first memory portion; and
a memory device comprising:
a nonvolatile semiconductor memory configured to store data; and
a device controller configured to control input and output of data for the nonvolatile semiconductor memory, and configured to transmit an input and output request for data to the host controller,
wherein in response to the device controller transmitting an output request, the host controller reads the first data and the tag information from the first memory portion based on the output request, and outputs the first data and the tag information to the device controller.

2. The information processing device according to claim 1, wherein the host controller outputs the first data and the tag information by a single sequence control based on the output request.

3. The information processing device according to claim 1, wherein the first data includes management information for the nonvolatile semiconductor memory.

4. The information processing device according to claim 3, wherein the management information includes table information associating a logical address with a physical address in the nonvolatile semiconductor memory.

5. The information processing device according to claim 1, wherein the first memory portion is a main memory in the host device.

6. The information processing device according to claim 1, wherein the memory device uses the first memory portion as a working memory area.

7. The information processing device according to claim 1, wherein the nonvolatile semiconductor memory includes a NAND flash memory.

8. The information processing device according to claim 1, wherein the host device and the memory device are compliant with UFS (Universal Flash Storage) protocol.

9. An information processing device comprising:
a host device comprising:
a first memory portion comprising a data area in which first data is stored, and a tag area in which tag information corresponding to the first data is stored, the data area and the tag area being allocated in continuous physical addresses in the first memory portion, and
a host controller configured to control input and output of data for the first memory portion; and
a memory device comprising:
a nonvolatile semiconductor memory configured to store data, and
a device controller configured to control input and output the data for the nonvolatile semiconductor memory, and configured to transmit an input and output request for data to the host controller,
wherein in response to the device controller transmitting an output request, the host controller reads the first data and the tag information from the first memory portion based on the output request, and outputs the first data and the tag information to the device controller.

10. The information processing device according to claim 9, wherein a data allocation in the data area has a set associative method including a first field and a second field.

11. The information processing device according to claim 9, wherein the host controller outputs the first data and the tag information by a single sequence control based on the output request.

12. The information processing device according to claim 9, wherein the first data includes management information for the nonvolatile semiconductor memory.

13. The information processing device according to claim 12, wherein the management information includes table information associating a logical address with a physical address in the nonvolatile semiconductor memory.

14. The information processing device according to claim 9, wherein the first memory portion is a main memory in the host device.

15. The information processing device according to claim 9, wherein the host device and the memory device are compliant with UFS (Universal Flash Storage) protocol.

16. An information processing device comprising:
a host device comprising:
a first memory portion configured to store first data, and
a host controller configured to control input and output of data for the first memory portion; and
a memory device comprising:
a nonvolatile semiconductor memory configured to store data,
a second memory portion configured to store tag information corresponding to the first data, and
a device controller configured to control input and output of data for the nonvolatile semiconductor memory and the second memory portion, and configured to transmit an input and output request for data to the host controller,
wherein the device controller reads the tag information from the second memory portion, and
wherein in response to the device controller transmitting an output request, the host controller reads the first data from the first memory portion based on the output request, and outputs the first data to the device controller.

17. The information processing device according to claim 16, wherein the host controller outputs the first data by a single sequence control based on the output request.

18. The information processing device according to claim 16, wherein the first data includes management information for the nonvolatile semiconductor memory.

19. The information processing device according to claim 18, wherein the management information includes table information associating a logical address with a physical address in the nonvolatile semiconductor memory.

20. The information processing device according to claim 16, wherein the host device and the memory device are compliant with UFS (Universal Flash Storage) protocol.
